(19) United States
(12) Patent Application Publication
(10) Pub. No.: US 2024/0418969 A1
(43) Pub. Date: Dec. 19, 2024

(54) HIGH-MAGNIFICATION PHOTOGRAPHY EXPLOITING POLARIZING BEAMSPLITTERS, WAVE PLATES, AND REFLECTORS

(71) Applicant: Lumenuity, Inc., Cabin John, MD (US)

(72) Inventors: Edo Waks, Cabin John, MD (US); Benjamin Shapiro, Los Angeles, CA (US); David Barsic, Los Angeles, CA (US)

(73) Assignee: Lumenuity, Inc., Cabin John, MD (US)

(21) Appl. No.: 18/781,114

(22) Filed: Jul. 23, 2024

Related U.S. Application Data
(63) Continuation of application No. PCT/US2023/061181, filed on Jan. 24, 2023.
(60) Provisional application No. 63/267,100, filed on Jan. 24, 2022.

(51) Int. Cl. G02B 15/00; G02B 27/28

(52) U.S. Cl. CPC G02B 15/00; G02B 27/283

(57) ABSTRACT

Described herein are systems and methods for enabling small high-magnification cameras to operate in low-light (e.g., night-time) conditions. These camera systems can include use of polarizing beamsplitters, waveplates, and reflectors to enable a long path of light in a camera. Also described are methods to enable a single camera to operate at two light paths and two focal lengths simultaneously. Two focal lengths (two magnifications) can be supported within a single camera or imaging device.

### CROSS-REFERENCE TO RELATED APPLICATION

This application is a continuation of International Patent Application No. PCT/US2023/061181, filed on Jan. 24, 2023 claims the benefit of U.S. Provisional Patent Application No. 63/267,100, filed Jan. 24, 2022, which is incorporated by reference herein in its entirety.

### TECHNICAL FIELD

This application relates generally to the field of high-magnification photography and imaging techniques. More specifically, this application relates to systems and methods that exploit reflectors and/or polarizers, including polarizing beamsplitters, for use in high-magnification cameras or imaging devices. The application also relates to imaging devices or cameras built into cell phones, smartphones, tablets, laptops, drones, or any other mobile devices.

### BACKGROUND

Digital cameras are widely used in mobile devices, for example in smartphones. Camera performance is a major differentiator for consumers and is a driver for market share. Hence mobile device makers and suppliers strive to improve camera performance.

One key aspect of mobile device camera performance is high-magnification (or high-zoom) photography. Typically, cameras or imaging devices that achieve high-magnification photography have long and large lens assemblies (e.g. zoom lenses in DSLR cameras). But mobile devices are thin and compact and cannot contain long lens assemblies. This has traditionally limited their magnification and zoom capabilities.

Accordingly, there is always a need for improved imaging systems and methods.

### SUMMARY

This application discloses systems and methods for improving the performance of high-magnification, low volume (e.g., thin) cameras or imaging systems. In particular, this application discloses using polarizing beamsplitters, waveplates, and reflectors or mirrors, to increase the path of light in the camera, which enables longer focal lengths and hence higher magnifications, but without a substantial loss of light. This enables, for example, high-magnification small-volume camera photography/videography in low-light conditions. It is useful both for long-distance smartphone photography/videography, and also for near-in ‘macro’ photography/videography (which means taking high-magnification photos or videos of small but nearby objects, such as an ant on a leaf). This application also discloses enabling multiple focal lengths in one camera, for example, to cover a larger range of focal lengths for improved zooming on objects that move towards and away from the camera.

One aspect provides methods and systems for improving the performance of high-magnification small-volume (e.g. thin) cameras or imaging systems, which include polarizations and internal reflections as part of their operation. Such small but powerful magnification cameras are advantageous for smartphones, tablets, drones, and for other mobile devices, or for use in small confined spaces such as in unobtrusive locations in self-driving vehicles. Having internal reflections inside a small camera or imaging system enables a longer path of light, and hence allows use of longer focal lengths, which in turn enables higher magnification. In particular, this application discloses the use of reflectors, beam-splitters, polarizers, and related elements to improve performance, including for enabling operation in low-light conditions.

Also described are methods to enable a single camera to operate at two light paths and two focal lengths simultaneously. This is enabled by splitting the light path into two, where each path is of a different length before it reaches an imaging sensor and therefore two focal lengths (two magnifications) can be supported at the same time within a single small camera or imaging device.

Another aspect includes an imaging or optical system for capturing an image having a lens or substrate having a focal length, a polarizing beamsplitter adjacent to the lens or substrate, a wave plate downstream of the reflective polarizing beamsplitter, a first reflector distal or downstream of the wave plate, a second reflector that is arranged at an angle between 20 and 170 to the first optical path, and a sensor to form the image. The substrate, wave plate, and reflector can be arranged in a first optical path, and the first reflective polarizer can be arranged in a first optical path between the lens and the first reflector. The sensor can be arranged in the first optical path or a second optical path. The polarizing beamsplitter can be on the intersection of the first and second optical path of the second reflector. The light entering the lens of the image is polarized by and transmits through the reflective polarizing beamsplitter, passes through the wave plate, hits the reflector, returns through the wave plate, along the first optical path; and the light then is reflected by the polarizing beamsplitter to along the second optical path, and forms the image on the sensor and the light forms the image on the sensor.

Another aspect can include the waveplate being a quarter-wave plate or rotator or plate.

Another aspect can include one or more additional lenses or substrates having a focal length and the lenses or substrates having spherical or aspherical curved surfaces.

Another aspect includes using cornering prisms or turning reflectors.

Another aspect includes the wave plate being composed of two or more elements.

Another aspect includes the first reflector or the second reflector that is curved, with spherical or aspherical curvature mirror.

Another aspect includes the focal length of the system matched to the round-trip length of the light path.

Another aspect includes the one or more of the lens or substrate, polarizing beamsplitter, wave plate, or reflecting surface or mirror being can be moved mechanically, whereby this is used to change the overall focal length of the imaging system.

Another aspect includes integration into a smartphone, cell phone, tablet, laptop, drone, or other mobile device.

Another aspect includes a system having a second imaging sensor, on the second light path on the other side of the polarizing beamsplitter from the first imaging sensor.

Another aspect includes the focal length for the image formed on the first sensor being different than the focal length for the image formed on the second sensor.

Another aspect includes the imaging sensor arranged at an angle between 20 and 160 degrees to the first optical path.

Another aspect includes taking high-magnification photographs or videos.

Another aspect includes taking photographs or videos in low-light conditions.

Another aspect includes taking both long-distance (tele) and near-in (macro) by the single imaging system. This can be enabled by moving optical elements in the system to change the focal length by a larger amount.

Another aspect includes a method including polarizing light into a first linear polarization, transmitting that polarization through a polarizing beamsplitter, a wave plate, and a reflector so that it returns to the beamsplitter with a linear polarization substantially orthogonal to the transmission linear polarization, and so is diverted by the beamsplitter to a sensor to form an image; whereby this enables a longer light path and hence higher magnification inside a small imaging system, and also allows operation in low light conditions.

Another aspect includes creating a composite image from images at two different focal lengths, whereby the user is provided with an image where two different distances are simultaneously in focus.

Another aspect includes selecting which portion of which image is in focus by autofocus hardware.

Another aspect includes the hardware is PDAF (phase detection autofocus) sensing.

Another aspect includes selecting which portion of which image is in focus by software.

Another aspect includes the composite image being formed by selecting which portion of which image is in focus by hardware and software.

Another aspect includes the second reflector arranged at an angle between 20 and 90 to the first optical path or at an angle between 55 and 90 to the first optical path.

Another aspect includes the wave plate arranged between the polarizer and the first reflector.

Another aspect includes a system including a second lens, a third mirror and/or wave plate is an optical film.

Another aspect includes a camera having the system disclosed herein or incorporating methods disclosed herein.

Another aspect includes a method of taking high-magnification imaging by receiving light from a scene through a substrate, wherein the substrate focuses the light, polarizing the light into a first linear polarization, rotating the light; diverting the light and rotating the polarization of the reflected light (a second time) so that the combination of the two polarizations rotates the polarization of the light to substantially orthogonal to the input polarization;

### BRIEF DESCRIPTION OF THE DRAWINGS

FIG. 1 shows an exemplary embodiment having a lens, a polarizing beamsplitter, a quarter-wave plate, a mirror, and a sensor; that allow high-magnification and low-light photography in cameras or imaging systems;

FIG. 2 shows the exemplary embodiment of FIG. 1 integrated into a smartphone;

FIG. 3 shows another embodiment having a turning mirror or cornering prism, integrated into a smartphone;

FIG. 4 another embodiment having a lens, a polarizing beamsplitter, a quarter-wave plate, a mirror, and a sensor; that enables high-magnification and low-light photography in phone cameras or imaging systems;

FIG. 5 shows the embodiment of FIG. 4 integrated into a smartphone;

FIG. 6 shows another embodiment that enables two light paths and two focal lengths in one camera or imaging system;

FIG. 7 shows another embodiment that enables two light paths and two focal lengths in one camera or imaging system;

FIG. 8 shows another embodiment that has two mirrors;

FIG. 9 shows another alternate embodiment related to FIG. 1, that enables two light paths and two focal lengths in one camera or imaging system;

FIG. 10 shows the embodiment of FIG. 9, with a cornering mirror added, integrated into a smartphone; and

FIG. 11 shows an advantage for optical element motion as it relates to varying focusing, for the disclosed embodiments.

### DETAILED DESCRIPTION

This application will now be described more fully with reference to the accompanying drawings in which preferred embodiments of the invention are shown. This invention may, however, be embodied in many different forms and should not be construed as being limited to the embodiment set forth herein.

This application discloses compact, small-volume cameras or imaging systems that make use of lenses, beam-splitters, reflectors, waveplate retarders, and/or light polarizing elements, and by doing so enables both high-magnification and low-light operation in a single camera. A key aspect herein is specific and innovative arrangements of one or more polarizing beam-splitters, wave-plates, reflectors, lenses and sensors. The arrangements ensure polarization orientations along the path of the light that set how the light progresses through the camera. They enable both a long path of light in a small volume (which permits a long focal length and hence high-magnification) and they ensure a substantial portion of the light entering the camera reaches the sensor to form an image (thus enabling camera operation at low light, e.g. at night time). The resulting embodiments enable small cameras or imaging systems that can achieve both high-magnification and low-light operation in a small volume. Such cameras or imaging systems can be advantageous for use in smartphones, tablets, drones, or other mobile devices.

In current smartphone camera modules, typically there is one camera (e.g. the telephoto camera) that is responsible for high-magnification photography or videography; and another camera (e.g. the normal or wide-angle camera) that is responsible for low-light (e.g. night-time) operation. Specific embodiments include methods and systems for a single camera that could take both high-magnification and low-light photographs or videos, and could do so both for long-range telephoto operation and for macro (closer in) photography/videography. Such embodiments can reduce the camera count, size and/or cost of camera modules and also allow the same or higher performance. Specific methods and systems also enable operation at two focal lengths at the same time, which can provide improved zooming on objects that move towards and away from the camera.

### High-Magnification and Low Light Camera Operation by Polarizing Beamsplitters, Waveplates, and a Mirror

Exemplary systems enable polarized round-trip light reflections, to allow a small-volume camera to conduct high-magnification photography/videography, and that also enable low-light operation. These aspects are achieved by exploiting reflections and polarizations to both enable a long path of light (which enables a long focal length and hence high-magnification), and also to substantially prevent loss of light, and thus to make sure a large amount of light reaches the sensor as is needed for low-light operation. This type of novel system is therefore suitable for use in mobile devices, e.g. in smartphones, to achieve both high-magnification (high zoom) and enable low-light operation. It could, for example, enable photography and videography of far scenes/objects at night, and macro-photography/videography in low light. Macro photography refers to high-magnification images of nearby but small objects, such as an ant on a leaf.

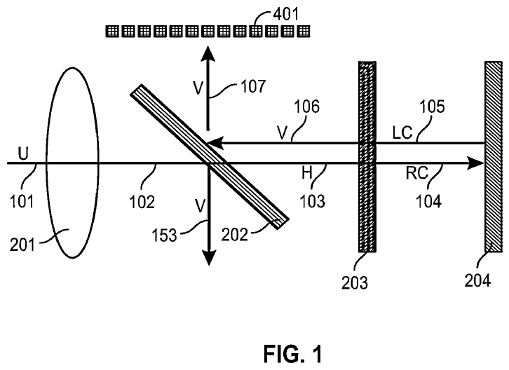

FIG. 1 shows an exemplary system composed of a lens or substrate (201), a polarizing beamsplitter (202), a wave plate or a quarter-wave plate (203), a reflector or mirror (204), and an imaging sensor (401). Since 203 is a quarter-wave plate, its phase delay is selected to be 90 degrees for a selected (visible) wavelength of light. A quarter-wave plate converts linearly polarized light into circularly polarized light, and vice versa. The quarter-wave plate can be oriented so that its optic axis is oriented substantially at a plus or minus 45-degree angle to the pass (transmit) polarization orientation of the beamsplitter.

The lens, beamsplitter, wave plate (e.g., quarter-wave plate), and mirrors are aligned substantially along the axial axis of the camera (along the incoming light 101); and the sensor (401) is aligned substantially off-axis at an exit port of the beamsplitter (202). This arrangement of the elements helps ensure polarization orientations along the path of the light that set how the light progresses through the camera. It enables both a long path of light in a small volume (which can permit a long focal length and hence high-magnification) and it ensures a substantial portion of the light entering the camera reaches the sensor to form an image (thus enabling camera operation at low light, e.g. at night time). The created polarization and resulting path of the light in the camera are now disclosed in detail.

Incoming light (101) from an object or scene is typically not polarized, and so is labeled ‘U’ for unpolarized light in FIG. 1. This light enters lens (201) and exits (102), and arrives at the polarizing beamsplitter (202) which, for example, only allows horizontally polarized light to transmit through it (103, and label ‘H’). The transmitted light (103) then enters a quarter-wave plate (203), and emerges circularly polarized (104), e.g. right-circularly polarized (depending on the choice of naming convention chosen, hence label ‘RC’ at 104). Light then reflects (105) from the reflector or mirror (204), and now has a left-circular polarization according to the same convention (hence ‘LC’ label at 105). It then makes a second pass through the quarter-wave plate (203). After the quarter-wave plate, the light emerges (106) linearly polarized, but now with a vertical linear polarization (hence ‘V’ label at 106). Thus, due to the action of the quarter-wave plate (QWP), the linear polarization of the return light is 90 degrees different at 106 (is vertically polarized) as compared to the entry light at 103 (which is horizontally polarized). Light then hits the polarizing beamsplitter (202) again, but this time it reflects (107) instead of transmitting because its polarization has been rotated 90 degrees (through the action of the quarter-waveplate (203)) and is now oriented perpendicular to the transmission polarization orientation of the polarizing beamsplitter (202). After reflection from the beamsplitter, then the light (107) reaches the sensor (401) to form an image.

In another embodiment, a single lens can be replaced by a lens group, or additional lenses can be added before or between the other elements. If the distance the light has traveled is matched to the focal length of the lens (or lenses), then the image formed on sensor (401) will be in focus. The path the light has traveled can be matched with the focal length of the camera lens or lenses.

In another embodiment, lenses can be added before or in between the elements shown in FIG. 1. Specifically, lenses can be added before the beamsplitting polarizer (202), or after it. Such lenses can have spherical or aspherical curved surfaces.

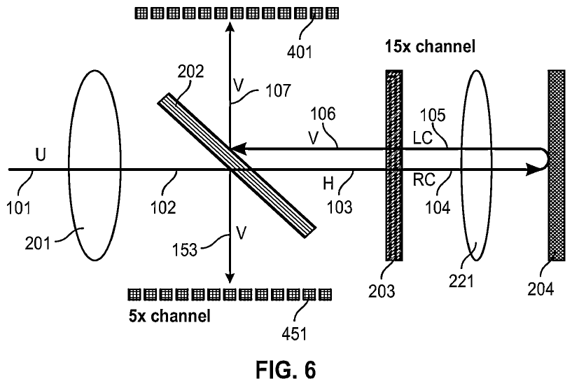

Lenses that can be added after the beamsplitting polarizer (202) and before the mirror (204) can have a double effect. Since light can pass through any such lens twice, once for the forward light path (103, 104) and again for the return light path (105, 106), e.g. see also FIG. 6 and lens 221, each lens in this in-between location will act to bend or focus the light twice. Thus, each such lens can have a stronger effect than it would otherwise. Therefore, less lenses could be used to achieve the same benefit of image focusing, or of reducing image aberrations. This is disclosed as an advantage for the current embodiments, both this embodiment and the other embodiments herein.

The mirror or mirrored surfaces (e.g. 204 in FIG. 1) can be curved, either spherically or aspherically. This can act as another light bending or focusing element. By curving the mirror, fewer other non-flat elements (e.g. fewer lenses) may be required.

For the exemplary embodiment illustrated in FIG. 1, the size of the system (the size and spacing of the components disclosed) can be such that the whole system can fit inside the thickness of a smartphone or other mobile device, e.g. inside a mobile or cell phone, a tablet, a laptop, or inside a small drone. Thus for the enablements disclosed herein, a central feature of these enablements is that they enable high-magnification and low-light photography for cameras that can be included in a smartphone, tablet, laptop, small drone, or other mobile devices.

In the following internally reflecting path illustrated in FIG. 1, the segments 105 and 106 retraverse a distance already covered by paths 103 and 104. Hence the resulting light path can follow a distance that can be longer than the thickness of the camera. This distance can be up to almost two times longer than the camera thickness, depending on the placement and thickness of the polarizing beamsplitter and mirror. This embodiment allows use of a longer camera focal length in a smaller space, e.g. for use inside a smartphone.

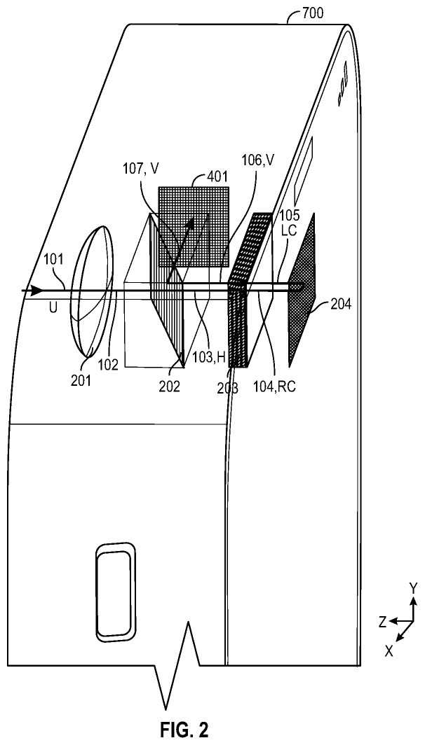

FIG. 2 shows an exemplary type of camera or imaging system that can be used inside a smartphone, tablet, laptop, or other mobile device. This is the exemplary system of FIG. 1, but now shown in more detail as its elements could be oriented inside a smartphone. It is composed of a lens or focusing substrate (201), adjacent to which is a polarizing beamsplitter (202), adjacent to which is a wave plate (203), and adjacent to which is a mirror or reflector (204), all arranged along a first optical path; and an imaging sensor (401) that is arranged along a second optical path. In the exemplary embodiment of FIG. 2, the lens (201), wave plate (203), and mirror (204) are placed along the first optical path, which is along the incoming light (along 101, along the Z axis); meaning 201, 203, 204 are oriented perpendicular to this first light path (in FIG. 2 they lie in the XY plane). The imaging sensor (401) is placed along the second optical path, which is along the light that reaches the sensor (along 107, i.e. along the X axis); meaning 401 is oriented perpendicular to this second light path (in FIG. 2 it lies in the YZ plane). The polarizing beamsplitter (202) is oriented so that its ports align with both the first and second optical paths; meaning specifically, two ports of the polarizing beamsplitter (that allow entry of light 102 and exit of light 103) are along the first axis or path of light (their faces are in the XY plane in FIG. 2); and a third port of the polarizing beamsplitter (that allows exit of light 107 from the beamsplitter) is along the second axis or path of light (its face is in the YZ plane in FIG. 2). In the illustration and example of FIG. 2, the two light axes or paths are shown as perpendicular to each other, and as aligned exactly along the cardinal axes of the smartphone (along exactly Z and X respectively), but we disclose that the invention remains operable if these paths or axes are not aligned perpendicularly, or if they are not aligned along the cardinal axes X, Y, Z of the smartphone, and doing so is disclosed.

As can be seen in FIG. 2, the exemplary system can be used in a smartphone to orient the optical axis of the camera (along 101) through the thickness of the smartphone. This arrangement can allow up to doubling-up the light path length (and hence focal length) available across the thickness of the phone. FIG. 2 shows such a case: the optical axis of the camera (along the incoming light path 101) can be aligned along the thinnest part of the phone (along the Z axis in FIG. 2). The sensor 401 can conveniently be aligned in the YZ plane (as shown), or in the XZ plane, but we disclose that other sensor orientations are also possible (e.g. not in the YZ or XZ plane but at an angle to them if desired, then the angle of the beamsplitter will need to be suitably modified away from substantially 45 degrees).

FIG. 2 shows that the orientation, scale and size of the camera embodiment can be integrated inside an exemplary smartphone. More specifically, the embodiment illustrated in FIG. 2 is also composed of a lens (201), a polarizing beamsplitter (202), a quarter-wave plate (203), a mirror (204), and an imaging sensor (401). Incoming typically unpolarized light (101) enters the lens (201) and exits it (102), and arrives at the polarizing beamsplitter (202) which, for example, only allows horizontally polarized light to transmit through it (103, and label ‘H’). This transmitted light (103) then enters a quarter-wave plate (QWP) (203), and emerges circularly polarized (104), e.g., right-circularly polarized (depending on the choice of naming convention chosen, hence label ‘RC’ at 104). Light then reflects (105) from the mirror (204), and now has a left-circular polarization according to the same convention (hence the ‘LC’ label at 105), and makes a second pass through the QWP (203). After the quarter-wave plate, the light emerges (106) linearly polarized, but now with a vertical linear polarization (hence ‘V’ label at 106). Thus, due to the action of the QWP, the linear polarization of the return light is 90 degrees different at 106 (is vertically polarized) as compared to the entry light at 103 (which is horizontally polarized). Hence when light hits the polarizing beamsplitter (202) again, this time it reflects (107) instead of transmitting because its polarization has been rotated 90 degrees (through the action of the quarter-wave plate (203)) and it is now oriented perpendicular to the transmission direction polarization of the polarizing beamsplitter. After reflection from the beamsplitter, then the light (107) reaches the sensor (401) to form an image.

The embodiment illustrated in FIG. 2 is a small cube-like camera design, which can enable a similar or better type of magnification than currently only available in larger-volume rectangular (one long axis) periscope camera designs. The embodiment can do so without a substantial loss of light, thus enabling its use for low-light (e.g. night-time) operation. When optical element motion and extra lenses are added, which is herein also disclosed, then this type of camera design can also further enable both macro and telephoto high-magnification low-light operation in a single camera. Being able to achieve these advancements and features is a desirable high-value use-case for smartphone applications, since it can potentially reduce both camera size, and decrease the number of cameras needed in a camera module by rolling two camera functions (high-magnification and low-light) into a single smaller camera.

To enable high-magnification low-light camera operation in a smartphone size and form factor, that is a central aspect and enablement of the current invention. In FIG. 2 there is free space shown between the components, e.g. a free space in the −X direction between the polarizing beamsplitter (202) and the sensor (401). But this is done primarily for purposes of illustration clarity, so that the reader can easily see all components of the embodiment. We note that the free space can be included, or the components may be brought closer together, as close as is desired or as is allowed by manufacturing or other considerations, and doing so is anticipated and disclosed.

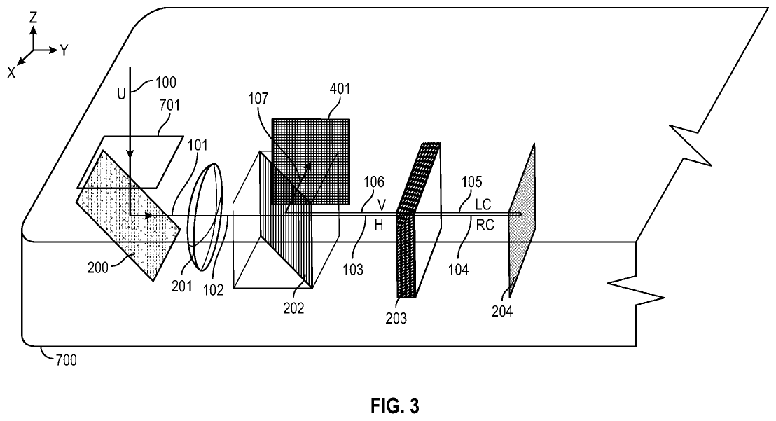

A second way the invention can be used is in combination with a periscope geometry. The invention illustrated in FIG. 1 may further include a cornering mirror or prism before or after lens 201, as illustrated in FIG. 3 for the case where a cornering mirror is before lens 201. In this embodiment, the aperture 701 can also be replaced by a lens or lenses if desired. Such a design, where the embodiment of FIG. 1 is used in a ‘periscope’ configuration, has an advantage over existing smartphone periscope camera designs. In an existing periscope design, the focusing path length available to the light is no more than the length of the long axis of the camera (along the Y axis in FIG. 3). This sets the available focal length, and hence the maximum magnification, of a conventional smartphone periscope camera. In the embodiment shown in FIG. 3, due to the polarizations (at 202) and the polarization rotations (at 203) and the reflection (at 204), up to almost double the length of the long axis of the camera is available for light travel, and hence for focusing and magnification.

In the current exemplary embodiment of FIG. 3, the light enters the smartphone along the −Z axis (ray 100) through aperture 701 (which can also be a lens, or a lens group), and is turned substantially 90 degrees by a turning mirror (200) or equivalently a cornering prism. The lens (201) can remain after the turning mirror or cornering prism (as shown in FIG. 3), or it can be placed before the turning mirror or cornering prism, in or near aperture 701. The light can then proceeds through the embodiment the same way as shown in and discussed for FIGS. 1 and 2. The difference is that now the axial direction of the camera is oriented along the Y axis of the phone (instead of along the thin Z axis as it was for FIG. 2). Or the camera could also be oriented so that its long axial direction is along the X axis of the smartphone. In either case, light traverses the long axis of the camera twice (from 202 to 204 and then back to 202). This means that the available light path travel distance, and hence available focal length, is from 201 to 204, back to 202, and then to 401, and therefore (depending on the size and placement of 202). This is almost twice as great as would be available for a conventional periscope design.

Hence for essentially the same camera volume as a conventional periscope camera, the available focal length and hence magnification is about twice as great. By exploiting a reflector and polarizing beamsplitter and quarter-wave plate, as herein disclosed, this 2× magnification benefit over a conventional periscope design is achieved without a substantial loss of light. The end result is a compact camera that improves magnification but is still appropriate for low-light operation. Such a camera or imaging system is of high value for smartphone use.

There is free space shown between the components, e.g. a free space in the −X direction between the polarizing beamsplitter (202) and the sensor (401) in FIG. 3. This free space may be retained, or the components may be brought closer together, as close as is desired or as is allowed by manufacturing or other considerations, and doing so is anticipated and disclosed.

Sensor 401 can be placed further out in the −X direction if desired, and this can be used to even further increase the available path the light will travel, and hence the available focal length for magnification. However, moving sensor 401 in −X provides less benefit than moving mirror 204 in the +Y direction, since the latter distance is traversed twice (as noted above) and therefore provides a greater increase in magnification per camera volume increase. If a designer wishes to increase magnification further in our embodiment, at the cost of increasing camera size, the 204 mirror +Y displacement choice will provide more magnification increase for a given camera size increase than a 401 sensor −X displacement, though both are disclosed as viable options.

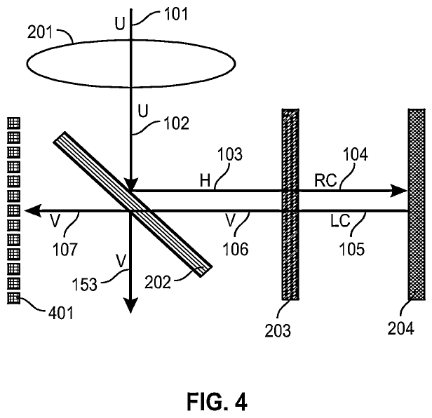

FIG. 4 shows an exemplary system composed of a lens (201), a polarizing beamsplitter (202), a quarter-wave plate (203), a mirror (204), and an imaging sensor (401). Since this embodiment includes a quarter-wave plate, its phase delay is selected to be 90 degrees for a selected (visible) wavelength of light. The quarter-wave plate is oriented so that its optic axis is oriented substantially at a plus or minus 45-degree angle to the reject (reflect) polarization orientation of the beamsplitter.

The sensor (401), beamsplitter (202), wave plate (203), and mirror (204) are aligned substantially along the axial axis of the camera (along 103, 104); and the entry lens (201) and incoming light (101) are aligned substantially off-axis at an entry port of the beamsplitter (202). This specific arrangement of the elements, as shown in FIG. 4, ensures polarization orientations along the path of the light that set how the light progresses through the camera. It enables both a long path of light in a small volume (which permits a long focal length and hence high magnification) and it ensures a substantial portion of the light entering the camera reaches the sensor to form an image (thus enabling camera operation at low light, e.g. at night time). The created polarization and resulting path of the light in the camera is now disclosed in detail.

As noted earlier, incoming light (101) from the object or scene is typically not polarized, and so is labeled ‘U’ for unpolarized light in FIG. 4. Unpolarized light contains both horizontal and vertical polarization components. This incoming light enters the lens (201) and exits it (102), and arrives at the polarizing beamsplitter (202) which, for example, only allows vertically polarized light to transmit through it (153, label ‘V’). Hence this polarizer rejects and will reflect out the horizontally-polarized component of the light. This means the horizontally polarized light is reflected out from the beamsplitting polarizer, at substantially a 90 degree angle (the light path 103, label ‘H’). This horizontally polarized reflected light then enters a quarter-wave plate (QWP) (203), and emerges circularly polarized (104), e.g. right-circularly polarized (depending on the choice of naming convention chosen, hence label ‘RC’ at 104). This light then reflects (105) from the mirror (204), and now has a left-circular polarization according to the same convention (hence ‘LC’ label at 105). It then makes a second pass through the QWP (203). After the quarter-wave plate, the light emerges (106) linearly polarized, but now with a vertical linear polarization (hence ‘V’ label at 106). Thus, due to the action of the QWP, the linear polarization of the return light (106) is now the same as light polarization that the polarizer will let pass (is 90 degrees different from the horizontal polarization that was previously rejected). Thus, this vertically polarized light (106, label ‘V’) will now pass through the polarizing beamsplitter and will reach the sensor (401) to form an image.

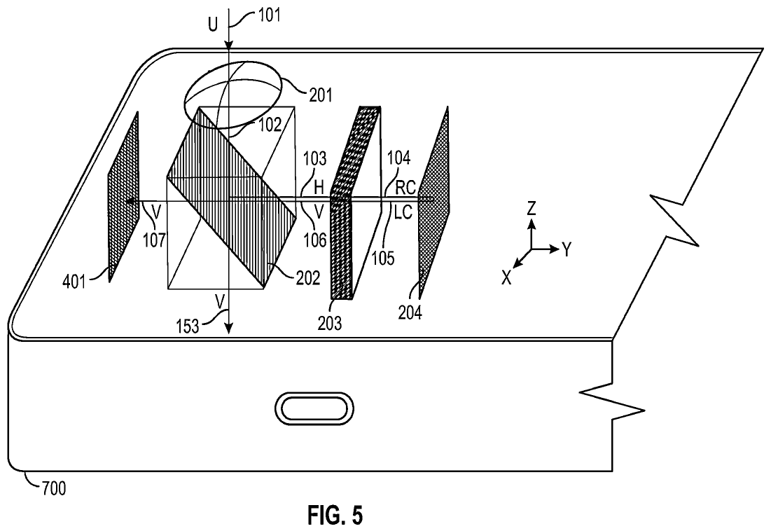

FIG. 5 shows the orientation of the camera along a long axis of a smartphone (along axis X or Y in FIG. 5) without requiring a cornering mirror or turning prism (e.g. without requiring element 200 in FIG. 3). Comparing FIGS. 4 and 5 to FIGS. 1 and 2, the orientation of the entry lens (201) and the imaging sensor (401) have been reversed. In FIG. 4 the entry lens (201) is now oriented horizontally, and the sensor (401) is oriented vertically; in FIG. 1 it was the reverse. Further, the sensor (401) has been brought to the front (left) of the camera in FIGS. 4 and 5.

These changes enable a periscope-like orientation of the camera, as shown in FIG. 5, but without needing a cornering mirror or turning prism. This means the length of the camera can be used more effectively. Now the entire camera length from 401 to 204 (along the Y axis in FIG. 5) can be used, at almost double-effectiveness due to the double-pass of the light from 202 to 204 and back, i.e. along 103, 104 for forward light and along 105, 106 for returning light. This is achieved without having an extra turning mirror or cornering prism (e.g. 200 in FIG. 3) that takes up some of the valuable available length. This is an added advantage of the embodiment shown in FIGS. 4 and 5. The embodiment of FIG. 4 can also be oriented along the other long axis of the smartphone (700), along the X axis (instead of along the Y axis as shown in FIG. 5).

More specifically, the embodiment of FIG. 5 is composed of a lens or focusing substrate (201), below which is a polarizing beamsplitter (202); on one side adjacent to which is a wave plate (203), adjacent to which is a mirror or reflector (204); on the other side of the polarizing beamsplitter the imaging sensor (401) is adjacent. The lens or focusing substrate (201) is placed along the first optical path, which is along the incoming light (along 101, i.e. along the Z axis in FIG. 5); meaning 201 is oriented perpendicular to this first light path (in FIG. 5 it lies in the XY plane). The imaging sensor (401), wave plate (203), and mirror (204) are placed along the second optical path, which is along the light that returns to the imaging sensor (along 107, along the Y axis in FIG. 5); meaning 401, 203, 204 are oriented perpendicular to this second light path (in FIG. 5 they lie in the XZ plane). The polarizing beamsplitter (202) is oriented so that its ports align with both the first and second optical paths; meaning specifically, one port of the polarizing beamsplitter (that allows entry of light 102) is along the first path or axis of light (its face is in the XY plane in FIG. 5); and a second and third port of the polarizing beamsplitter (that allows exit of light 103 and exit of light 107) is along the second path or axis of light (the faces of these ports are in the XZ plane in FIG. 5). In the illustration and example of FIG. 5, the two light axes or paths are shown as perpendicular to each other, and as aligned exactly along the cardinal axes of the smartphone (along exactly Y and Z respectively), but we disclose that the invention remains operable if those axes are not aligned perpendicularly, or if they are not aligned along the cardinal axes X, Y, Z of the smartphone, and doing so is disclosed.

The size of the system (the size and spacing of the components disclosed) can be such that the whole system can fit inside a smartphone or other mobile device, e.g. inside a mobile or cell phone, a tablet, a laptop, or inside a small drone. FIG. 5 shows how the embodiment of FIG. 4 can be integrated into a smartphone (700). Thus a central feature of this enablement is that it enables high-magnification and low-light photography for cameras that can be integrated into a smartphone, tablet, laptop, small drone, or other mobile device.

In FIG. 5, the long axis of the camera (from beamsplitter 401 to mirror 204) is shown along the longest Y axis of the smartphone. But the camera could be equally oriented along the medium-length X axis of the smartphone if desired. It could also be oriented at some angle in the XY plane, although this would typically not be convenient. Either way, there is freedom to choose the spacing lengths from sensor 401 to beamsplitter 202 to mirror 204 as desired. We note that increasing the distance from sensor 401 to beamsplitter 202 may be less desirable than increasing the distance from beamsplitter 202 to mirror 204, because the latter distance is traversed twice by the path of the light (once by the forward path 103, 104, and again by the return path 105, 106). Therefore, for an available or selected camera length, the designer may choose to place the beamsplitter 202 and the input lens (201) (or camera aperture), more to the left in FIG. 5 (towards −Y) because this will enable a longer total light path length, hence longer focal length and higher magnification, for a given camera length.

### Enabling Multiple Focal Lengths in One Small Imaging System

Disclosed next are exemplary systems that allow operation at multiple focal lengths. In a camera, such as used in a mobile device, an object may be photographed or videographed at different distances. For example, the user may take a video of an object that is approaching or receding, or the user may move towards or away from an object while taking a video or photos. That means it is desirable for the camera to be able to focus on an object or scene at a range of distances, e.g., continuously from a short to a long distance. Currently, in mobile devices, lenses or other optical elements can be mechanically moved to change the focus of a camera. However, the range of mechanical motion of elements (e.g., lenses) in a mobile device is limited by the thickness of the device, or by the length of the camera, and/or by the amount of room taken up by other elements. For example, if a mobile camera is 10 millimeters long, e.g. to fit inside the thickness of a smartphone for a non-periscope camera geometry, and non-moving lenses, PCB board, and sensor take up 6 millimeters of that space, then only 4 millimeters is left in order to execute lens motion to change focal length. For a periscope type camera, the values above would be different, but there would still be a limit on the camera length due to the need to fit many other components into the smartphone. Thus how much cameras can change focal length in a smartphone or other mobile devices can be limited.

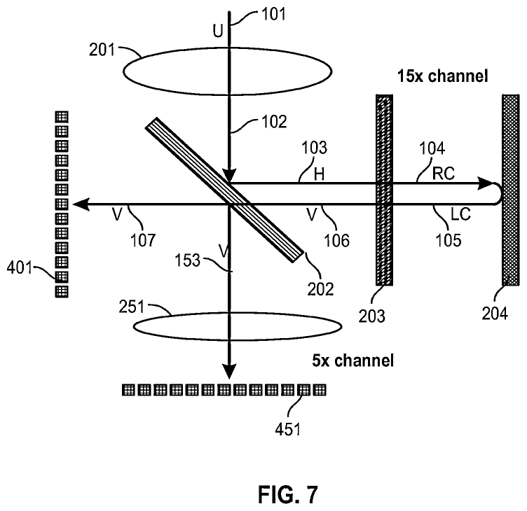

Exemplary systems shown in FIGS. 6 and 7 are systems that can improve camera focusing performance. The disclosed embodiments allow two focal lengths in one camera, which, for example, can permit a larger range of focal lengths for zooming. These exemplary systems contain one or more lenses, a polarizing beamsplitter (202), a quarter-wave plate (QWP, 203), a mirror or mirrors (e.g. 204) or other elements that act as reflecting elements, and a sensor or sensors (401, 451). Specifically, for the exemplary system disclosed in FIGS. 6 and 7, there are two paths of light in one camera, and each path of light can have a different path length and therefore can support a different focal length. In these example systems, the “15× channel” path has light that travels approximately three times (3×) the distance of the “5× channel”. It is understood that “15×” and “5×” are just two examples. The embodiments could equally have an “A×” and “B×” channel, where A is one level of magnification, and B is another level of magnification, and the light paths and focal lengths are matched to the selected A and B values. Further, these figures show two separate sensors, but we disclose that it is also possible to use two portions of one sensor, and doing so is anticipated.

Two focal lengths can have advantages as compared to just a single focal length. For example, two focal lengths can more easily cover a range of desired focal lengths than the one-at-a-time focal length that is available in conventional cameras. For instance, an optical element or elements may be moved to vary the first “5×” focal length from 1× to 10×. Likewise, an optical element or elements may be moved to vary the second “15×” focal length from 10× to 20×. Thus the range that would be covered in total would be 1× to 20×, which could be substantially greater than what could be covered by a conventional camera with a moving optical element or elements. This would allow an improved range of magnification. It can also allow improved zooming, and an improved ability to keep an object in focus as it moves towards and away from the camera.

FIG. 6 shows an exemplary system composed of at least one lens (label 201), a polarizing beamsplitter (202), a quarter-wave plate (203), a mirror (204), and two imaging sensors (401 and 451). The path of light for one channel, e.g., the “15× channel”, is the same as shown in FIG. 1. The path of light for the other channel is the path of light that was previously unused (153) in FIG. 1. But now that light is picked up by the additional sensor (451).

FIG. 7 shows an alternate exemplary system composed of at least one lens (label 201), a polarizing beamsplitter (202), a quarter-wave plate (203), a mirror (204), and two imaging sensors (401 and 451). Here the path of light for one channel, e.g. the “15× channel”, is the same as shown in FIG. 4. The path of light for the other channel is the path of light that was previously unused (153) in FIG. 4. But now that light is picked up by the additional sensor (451).

For the embodiments of FIGS. 6 and 7, lenses can be added along the first channel, along the second channel, or along both channels. Such lenses can be used to set the focal lengths to be different along the two channels, to desired values. We note that for lenses that are traversed twice by the light, due to a round-trip reflection, those lenses can have a stronger effect since they will focus the light twice for the same lens. The first lens can also be replaced by a simple aperture, if so desired.

It is understood that picking up the previously unused portion of the light (153), as shown in FIGS. 6 and 7, can be done for various embodiments disclosed herein that use a polarizing beamsplitter. It also may be done for variations of those embodiments, as herein anticipated and disclosed.

As noted above, the exemplary systems of FIGS. 6 and 7 can be configured to operate at two different focal lengths, i.e. at two different magnifications. Alternatively, the magnification for the two channels can be kept the same, but the focal depth can be made different for one channel versus the other.

Next is disclosed another advantage of these embodiments. Consider a scene that has two camera-to-scene distances of importance. Some examples: a couple may be taking a selfie in front of a historic building and there is the distance A from the smartphone camera to the couple, and the distance B from the smartphone camera to the building, where B is not equal to A. Or the couple could be taking a photo or video in front of a natural scene, such as a range of mountains behind them. Here there is a distance A from the camera to the couple, and a much larger distance B from the camera to the mountains. Or, in a macro photography setting, there may be a butterfly on a leaf and then the rest of the tree behind the butterfly. There are many other instances where there may be substantially two (or more) distances of interest from camera to the scene to be photographed or videographed.

For a conventional smartphone camera, the user has to pick: either the couple is in focus, or the historic building is in focus, but not both. The embodiments of FIGS. 6, 7, 9, 10, and variations thereof, enable a solution to this issue. The two channels enable two simultaneous photographs or videos of such scenes, where one photograph or video is taken via one channel on one sensor (e.g. 401) at one focal length (e.g. matched to distance A), and another photograph or video of the same scene is taken via the second channel on the other sensor (e.g. 451) at a second focal length (e.g. matched to distance B). Alternatively, as earlier disclosed, both photos or videos for both channels can be taken on two portions of one sensor.

Specific embodiments can provide a composite photograph or video formed from the two channels, and this composite photo or video would be formed in such a way that the scene would be presented to the user as substantially in focus at both distance A and distance B. Meaning, to return to one example above, both the couple and the historic building would be in focus on the composite images displayed or provided to the user.

If this region of the scene corresponds to a location taken up by the couple, then this first region of the scene will be substantially in focus in the first channel that ends in the first sensor (401), and whose focal length has been matched to distance A by appropriately moving optical elements along that first channel. But this same region will be out of focus on the second channel that ends in the second sensor (451), and whose focal length has been matched to distance B by appropriately moving optical elements along that channel. Thus, in the composite photo shown to the user, the image for this region should be taken from the first and not the second sensor.

If conversely, this region of the scene corresponds to a location taken up by the historic building, then this region will be substantially in focus on the second but not the first channel. Hence in the composite image shown to the user, the image for this region should be taken from the second and not the first sensor.

Selecting which region to display from which channel or sensor can be achieved by either using available sensor hardware; or by software operating on the embodiments of FIGS. 6, 7, 9, 10, or their variations; or a combination of the two. In terms of hardware: we disclose that sensors, including smartphone camera sensors, can include PDAF (phase detection autofocus) sensing components. PDAFs look at light coming from the same region of the scene, but entering the image sensor from different directions (e.g., converging to that location from the left or right side of the lenses, or from the top versus bottom). If the light is in phase from such different directions, then that region of the scene is in focus. We disclose PDAFs can be used to discern if the small region in question is more in focus on the first or second sensor. Other auto-focus hardware solutions commonly used in phones can also be used. Based on this the more in-focus version of each small region can be selected, and these can be combined into one composite image. The resulting composite image can therefore have both the couple and the historic building substantially in focus, an outcome that is not currently possible in conventional smartphone cameras.

Which small region to display from which sensor, to form a doubly in-focus composite image, can also be decided by software. Comparing image contrast for each small region across both sensors is one way. For example, the contrast between edges in that region can be used as the selection criteria. Another way is to use low-pass spatial filtering. If a small region is out-of-focus on a sensor, then applying a low-pass (smoothing) spatial filter will not change the image much, because that part of the image is already blurred. We disclose subtracting the low-passed version of an image from itself, for each small region. For regions where the image and its low-pass version differ substantially, that part of the image is more in focus. Thus this software method (low-pass filtering and subtraction) can be used to discern whether a region of the scene is more in-focus on the first or second channel or sensor. Once that discernment has been made, the more in-focus version of each region can be used to form the composite image for the user. Other software methods known in the art can also be used to decide if a small region is more in focus on the first or second channel or sensor, and are anticipated and disclosed.

When the composite image is formed, the difference in magnification across the two channels will be accounted for. Specifically, if there is a pattern of in-focus regions on the first sensor, forming a partial (patchworked) first image; and there is a complementary set of in-focus regions on the second sensor, forming a partial (patchworked) second image. It is understood that when these two images are combined into one composite image, one or both of them will be scaled (expanded or shrunk) to undo the difference in magnification for channel one versus channel two. They can also be centered on each other if needed.

It is further understood that the above is an approximate description. There may be some parts of the scene that are neither at distance A or B, for example, there may be a tree that is further behind the historic house, at a distance C from the camera that is not equal to either A or B. Scene regions corresponding to this tree can be displayed in the highest focus available. Likewise, the house may not be entirely at exactly distance B, nor all of the couple at exactly distance A. Again, for each small region, the version that is in best focus from the two channels or sensors can be presented to the user. Interpolating between the two channels; one or many portions of the composite images may be a combination of images from both channels. Further, the distances A and B are themselves ranges, such ranges corresponding to the depth of focus of each channel of the camera. So, in the above, the couple would be substantially in-focus from some distance from Amin to Amax, and the historic house would be in-focus from Bmin to Bmax.

In FIGS. 6, 7, 9, 10, and variations thereof, there are two focusing ranges available. This double focusing can be used to provide composite photos and videos that substantially have both distance ranges in focus in each composite image. Doing so is disclosed, is not available for conventional cameras, and forms a valuable benefit of the current invention.

Sometimes a user may desire that one part of the scene, e.g. the central subject of the scene, be in focus; and that the rest of the scene be out of focus (blurred) in order to draw visual attention to the subject of the scene. This is commonly referred to as a Bokeh effect in taking a photograph or a video. By being able to focus two channels independently, at different focal distances, the current invention can also be used to achieve such a Bokeh effect more readily. It can do so by selecting one of the two channels to be more out of focus; and by creating a composite image where parts of the scene are intentionally selected to be out of focus; and/or by a combination of both methods.

FIGS. 6, 7, 9, and 10 show an embodiment that can enable a more accurate separation of a target object from its background. For example, if the background is a distraction, e.g. is essentially camouflage for the object of interest, then if the scene can be separated into two in-focus elements one for the object and one for the background, then a composite photograph can be created where the target object is shown clearly and the background is shown, shown less, or hidden as desired.

### Additional Disclosed Aspects for the Embodiments

Herein we disclosed additional aspects and features of the invention. The features disclosed herein are anticipated for one, multiple, or for all of the embodiments above. A key aspect herein is specific and innovative arrangements of one or more polarizing beam-splitters, wave-plates, reflectors, lenses and sensors. The disclosed arrangements set polarization orientations along the path of the light and this selects how the light progresses through the embodiments. The selections disclosed herein enable both a long path of light in a small volume (which permits a long focal length and hence high magnification) and they ensure a substantial portion of the light entering the camera embodiments reaches the sensor to form an image (thus enabling camera operation at low light, e.g. at night time). The resulting embodiments enable small cameras or imaging systems that can achieve both high-magnification and low-light operation.

Optical elements can be added, for instance to further improve performance. For example, in order to reduce imaging aberrations, one or multiple lenses or focusing substrates may be added of spherical or aspherical curved surfaces; before, between, or after the polarizers and rotators.

It is also possible to add in additional turning mirrors or cornering prisms, for example immediately before or immediately after a first lens, so that the light path is bent by substantially 90 degrees. This can allow the imaging system to operate along the length (rather than the width) of a mobile device, and thereby can increase the available length for the light path.

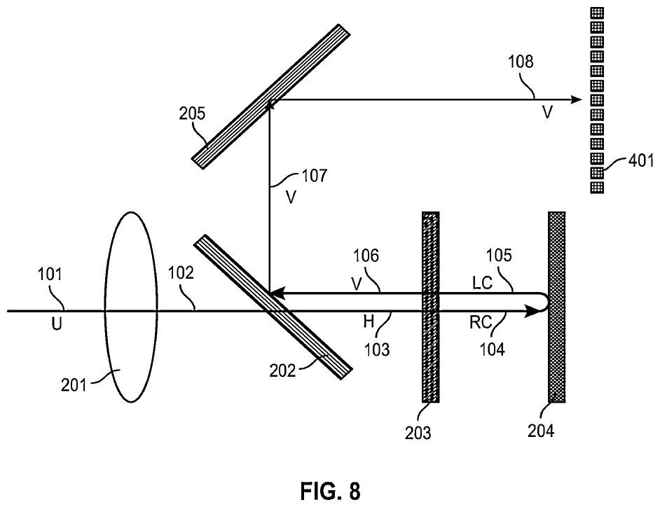

FIG. 8 shows the embodiment of FIG. 1, but a turning mirror (205) has been added. This mirror allows the sensor to be rotated in orientation substantially 90 degrees as compared to FIG. 1. It also allows the light path lens to be further increased, if desired, although we note as previously that this increase can be less advantageous than increasing the distance from the beamsplitter 202 to mirror 204 since the latter distance is traversed twice by the light (103, 104 and 105, 106) and so allows a greater increase in total light path length for a given increase in camera volume. We also disclose that the turning mirror may be oriented differently so that the sensor (401) can be in the plane of the page for FIG. 8 rather than oriented vertically.

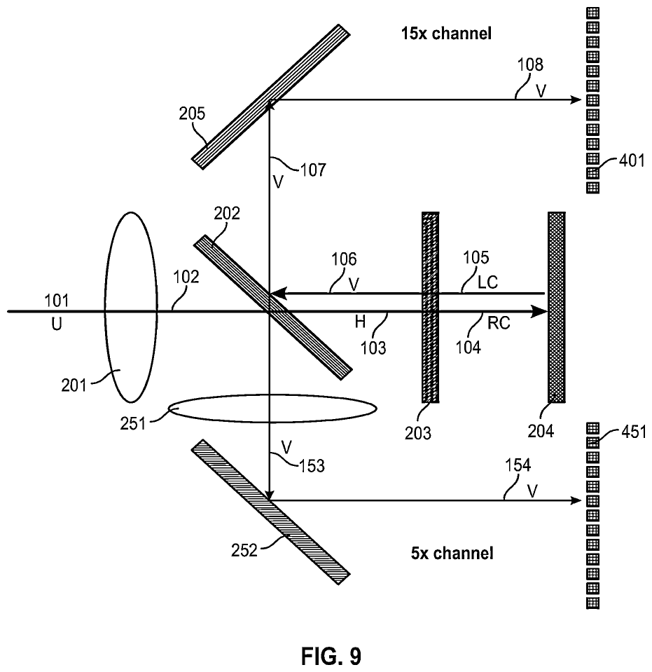

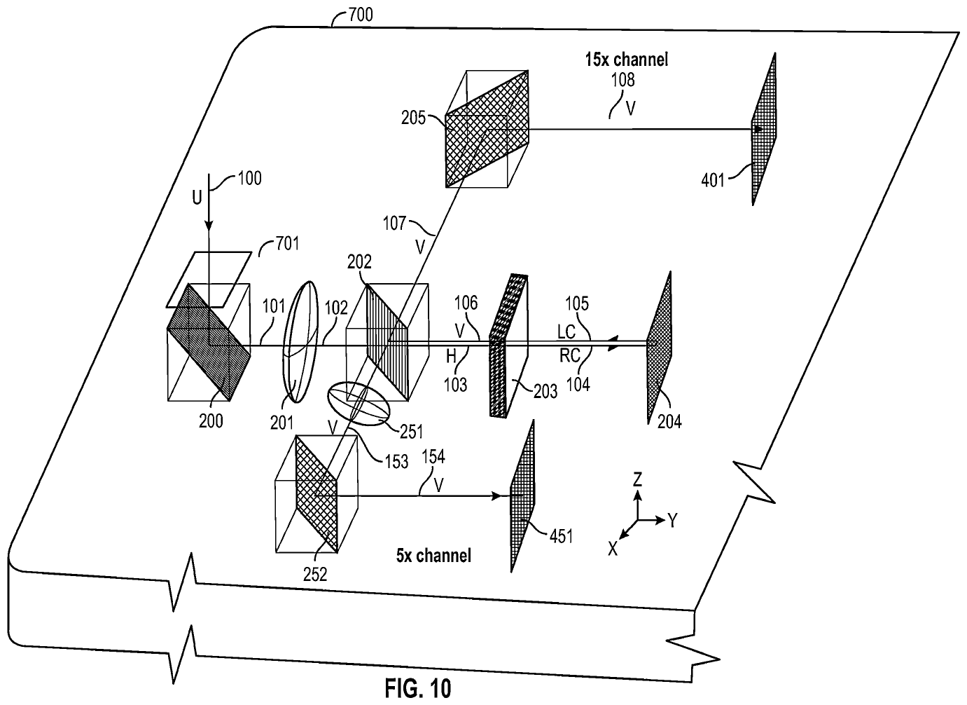

FIGS. 9 and 10 illustrate that turning mirrors can be added to both channels of the embodiment of FIG. 6, or the designer can elect to add a turning mirror in one channel but not the other. Here FIG. 10 shows how the variation of FIG. 9 has the right size and scale to be included into a smartphone. Compared to FIG. 6, the variation of FIGS. 9, 10 allows both sensors (401 and 405) to be rotated substantially 90 degrees. Or just one of them may be rotated substantially 90 degrees, if so desired.

Such additional turning mirrors can be added to other disclosed embodiments, if so desired. The turning mirrors can also be cornering prisms. Further, it can be any element that acts as a reflector. For example, a polarizer that does not pass (that reflects) vertically polarized light will also function as a mirror for the examples of FIG. 8, 9, or 10. For example, replacing element 205 in FIG. 8, 9, or 10 by a polarizer whose polarization is oriented to reflect the light path (107) will cause that element to act as a reflector, and is anticipated in the current disclosure. Also anticipated is orienting the added reflective surface in such a way that light is reoriented in other directions, for example into the +or −Z direction in FIG. 10. Doing so will enable one or both of the sensors (401 and 451) to be oriented in the YX plane of FIG. 10.

A person familiar with the art of optics will recognize that there may be other modifications and variations that are possible in light of the above teachings, or that may be acquired from practice of the invention. Such modifications as are suited to the particular use contemplated are anticipated, and are covered by this disclosure.

In some embodiments, a single lens can be replaced by a lens group, or additional lenses can be added before or between the other elements. An aperture, e.g. aperture 701 in FIGS. 3 and 10, may also be replaced by a lens or lenses. Or, vice versa, the first lens, e.g., lens 201 in the figures, can be replaced by an aperture and needed lenses can be placed after the aperture.

It is disclosed that elements or their surfaces may be curved, instead of flat. Or curved optical surfaces may be placed before or after disclosed elements. Specifically, mirrors or mirrored surfaces may be curved, either spherically or aspherically. In FIGS. 1 to 11 the reflecting mirrors may be curved. If it is desired that the quarter-wave plate (e.g. 203 in FIGS. 1 to 11) remain as a flat element, but to bend light coming into or out of it, then a curved optical lens or half lens can be placed before 203, after 203, or both. Further, if such components are available, one, some, or all of the polarizers and waveplates may be curved or shaped, instead of remaining flat. Overall, one, some, or many elements can be curved, or can have curved surfaces, or can have curved optical elements before or after them.

Any of the optical elements in the embodiments may be moved over time, e.g. translated or tilted, or for some element types their shape may be adapted over time. Such motion or shape change is commonly used to change focus in cameras and imaging systems, and/or to correct for video jitter, and the same can be used in the systems disclosed herein. There are many ways to affect such motion, including piezo, electrostatic, magnetic, motor actuated rack-and-pinion, MEMS (micro-electro-mechanical system) actuators, or other types of actuation. Including such movement is disclosed for our embodiments.

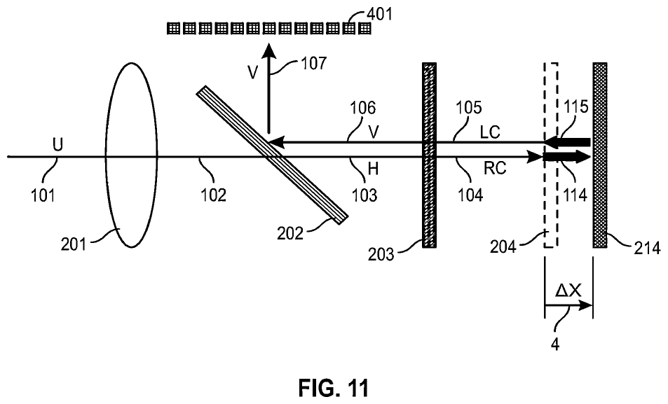

Specific embodiments disclosed can enable more camera performance for the same amount of element motion. Consider for example the embodiment of FIG. 1. If mirror 204 is moved to the right by an amount AX, then the change in light path length is double that amount, is 2 ΔX. This is shown in more detail in FIG. 11. For the mirror motion ΔX (label 4), the light from lens (201) to sensor (401) traverses the distance the mirror has displaced twice over. It traverses it in the forward direction (added light path 114), and again in the return direction (added light path 115).

The above double-the-motion benefit is advantageous for small camera applications, including for cameras in smartphones and other mobile devices. In such cameras, the amount of space available for element motion is limited. Thus extracting more change in light path and hence more focusing change, from the same amount of element motion, is highly desirable. The above advantage was presented in the context of the embodiment of FIG. 1, but it is equally true for other embodiments presented herein.

As shown in FIGS. 2, 3, 5, and 10, for example, there is free space shown between the components, e.g. a free space in the −X direction between the polarizing beamsplitter (202) and the sensor (401) in FIGS. 2 and 3. But this is done primarily for purposes of illustration clarity, so that the reader can easily see all components of the invention. We note that this free space may be retained, or the components may be brought closer together, as close as is desired or as is allowed by manufacturing or other considerations, and doing so is anticipated and disclosed.

The disclosed embodiments have been selected to enable low-light operation, in addition to high-magnification. Low-light has been achieved by inventively selecting designs that deliver a substantial portion of the light to the sensor, e.g. almost all light of one type of polarization. We note that delivering a substantial amount of light to the sensor enables a better signal-to-noise ratio. When there is more light reaching the sensor, the signal from the object or scene is higher compared to the dark noise level of an imaging sensor (dark noise is the amount of sensor noise when there is no light reaching the sensor). By keeping the amount of light reaching the sensor at a high level, signal-to-noise is increased, and this in turn enables the camera to operate successfully with less light, i.e. at lower light levels.

Specific embodiments can make use of linear and circular polarizer elements. Such polarization elements may include but are not limited to: thin film polarizers, micro wire-grid polarizers, wave-plates, liquid crystal rotators, Fresnel rhombs, and similar devices. One or more of the polarizers can be adjustable polarizers, such as liquid crystals polarizers whose polarization orientation may be changed by applying voltages. The polarization rotators, e.g. a quarter-wave rotator, may also be implemented via multiple different means, and may also be adjustable.

The disclosed polarizing beamsplitter referred to in the embodiments can also be: a polarizing beamsplitter cube, a plate polarizing splitter, a Glan-Thompson prism, a micro-grid polarizer, a reflective polarizing film, or any other type of beamsplitting polarizer. Likewise, the quarter-wave plate can also be: a quarter wavelength rotator or retarder, a Fresnel rhomb retarder, a birefringent crystal, a material or component with different refractive indexes that achieves a retardation of light along preferentially one axis over another, a material or component that dephases one element of light polarization from another, or any other type of waveplate retarder.

The mirror or reflector can be manufactured from metal, semiconductor or dielectric substrates and coated with reflective metal or multi-layer dielectric reflectors, or any other type of reflective or mirror component, for example as is used in smartphone cameras or other types of cameras or imaging systems.

The imaging sensor can be a time-integrating sensor, a CCD (charge-coupled device) sensor, a CMOS (complementary metal oxide semiconductor) sensor, avalanche photodiode arrays, photomultiplier arrays, nanoparticle or nano-material based sensors, grayscale or color sensors, any type of sensor used in smartphone or mobile device cameras, or any other type of sensor.

It is understood that various stated numbers are not exact values, but can have variations. For instance, a quarter-wave plate or quarter-wave rotator will introduce a substantially 90 degree (pi/2) phase shift of the light. However, the amount will not and need not be exactly 90 degrees, both for reasons of light optics (light at different incidence angles, or at different wavelengths of light will undergo different phase shifts) and for engineering or manufacturing reasons (variations in wave plate thickness e.g. due to manufacturing variations) which will also introduce changes in phase shift. The current disclosure covers such variations away from an “ideal” 90 degree phase shift values, both for unavoidable reasons (such as above) or for intended reasons if the system designer wishes to change the phase to accommodate system constraints. Other similar cases, such as “90 or 45 degree” polarization, “5× or 15×” magnification, etc., are also similarly covered, and are understood to be example or approximate numbers.

Some numbers are also understood to include their logical opposing sign counterpart. For example, a person knowledgeable in the field of optics will recognize that the systems disclosed herein will work equally well if +90 or +45 degrees is replaced by −90 or −45 degrees, so long as the embodiment inter-relation between polarizations is kept self-consistent. Likewise, for linear polarizations, for left or right handed circular polarization, or for elliptical polarization, there are changes in sign or via the addition of an overall positive or negative phase, that will not change system operation. Such replacements are understood to be anticipated, and are covered by the present disclosure.

For example, in relation to FIGS. 1 to 11, specific embodiments could operate with the polarizing beamsplitter and other components chosen so that each horizontal polarization (label ‘H’ in the figures) was replaced by vertical polarization (‘V’), and vice versa. For example, in FIG. 1, the polarizing beamsplitter 202 could be so oriented that 103 is vertically linearly polarized (‘V’ instead of ‘H’), then the return path 106 would be horizontally (‘H’) polarized. It would still be the case that the light exiting and returning to the polarizing beamsplitter (202) would still differ by 90 degrees, hence the overall path of the light and system operation would remain as shown in FIG. 1 (except every ‘H’ would be replaced by a ‘V’, and vice versa). In this sense, changing the orientation of the polarizing beamsplitter (202) by 90 degrees would leave the system operational, and is anticipated and disclosed.

Changing the orientation of the polarizing beamsplitter (202) by any other angle that is not 90 degrees, this is also a change with respect to an arbitrary convention on what is selected to be called horizontal or vertical polarization, and making such a change also would leave the system operational. Any such change is understood to be the addition of an arbitrary phase angle, and can be selected as desired (for example to align polarization at the sensor with an axis that is convenient for design of the system), and is also anticipated and disclosed. It is understood and disclosed for the embodiment of FIG. 1, as well as for other embodiments disclosed in this invention.

The term “polarizing beamsplitter” refers to a polarizing beamsplitter that divides incident unpolarized light into two orthogonally polarized beams. Most high-performance polarizers are based on birefringent crystals. Unpolarized light is incident internally on a tilted surface, so as to transmit one polarization and reflect another.

Phase-shifted combinations of linear polarization states will create what is termed circular polarization states. Circular polarization can be left-handed (rotating counter-clockwise as the beam propagates) or right-handed (rotating clockwise). It is disclosed that left-and right-hand polarization states are orthogonal and can therefore also be used as polarization states in the disclosed invention, similar to how horizontal and vertical linear polarization are used. There are also elliptical polarization states that are neither fully linearly nor fully circular, but are a combination. We disclose that elliptical polarization states are also contemplated in the current invention and may also be used. It is known that a Poincare sphere can be used to represent polarization states, and any polarization (linear, circular, or elliptical) can be represented on this sphere. We disclose that linear and circular polarizations are just specific special cases, and that more generally the inventions disclosed herein can use polarizations that are anywhere on the Poincare sphere and that are, for example, substantially orthogonal relative to each other, or that occupy points that are not immediately adjacent on the Poincare sphere.

It is further disclosed that there are many known ways to practically accomplish some of the elements listed as components in the disclosed embodiments. For example, lenses can be made from glass or plastic or other materials. They can be made using traditional grinding and polishing, single point-diamond turning, molded, 3D printed, or lithographically defined. In addition, lenses or substrates having a focal length can also be made through the use of holography, diffractive optics, gratings, two and three-dimensional photonic crystals, meta-lenses that use microstructured metal and dielectric materials as well as gradient index materials. Polarizers can be made from a variety of materials, such as polymer material with oriented polymer chains like Polaroid polarizers, liquid crystal materials, oriented elongated metallic nanoparticles embedded in glass, crystal or polymer, Fresnel reflection from dielectric surfaces, birefringent crystalline materials, thin film and micro-scale wire grid materials, or other materials.

Waveplates or wave rotators can be made from a variety of birefringent materials, such as thin films of crystalline material, oriented polymers, liquid crystal materials, and prism based rotators, or other materials.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. Overall, the embodiments herein were chosen and described in order to explain the principles of the invention and its practical application to enable one skilled in the art to utilize the invention in various embodiments. Modifications as are suited to the particular use contemplated are anticipated, and are covered by this disclosure.

What is claimed:

1. An imaging system for capturing light to form an image comprising:
a polarizing beamsplitter,
a substrate with a focal length,
a wave plate,
a reflector,
and an imaging sensor;
wherein the polarizing beamsplitter, wave plate, substrate with a focal length, and reflector are arranged along an axis, with the substrate positioned between the polarizing beamsplitter and the reflector, and the wave plate located between the polarizing beamsplitter and the reflector.

2. The system of claim 1, wherein the sensor captures the image with the light that reaches the sensor.

3. The system of claim 2, wherein the image is in focus.

4. The system of claim 2, wherein the wave plate is a quarter wave plate.

5. The system of claim 2, wherein the substrate is a lens.

6. The system of claim 2, wherein the substrate resides between the polarizing beamsplitter and the wave plate.

7. The system of claim 2, wherein the substrate resides between the wave plate and the reflector.

8. The system of claim 7, wherein the reflector is a mirror.

9. The system of claim 7, wherein the path of light reflected by the polarizing beamsplitter forms a substantially 90-degree angle with the incoming light.

10. The system of claim 7, wherein the sensor is aligned on-axis at an exit port of the polarizing beamsplitter.

11. The system of claim 7, wherein an optic axis of the quarter wave plate is rotated 45degrees relative to the polarization direction of the light reflected by the polarizing beamsplitter.

12. The system of claim 7, further comprising a second substrate with a second focal length, wherein the second substrate is aligned substantially off-axis at the entry port of the polarizing beamsplitter.

13. The system of claim 12, wherein the sensor is off-axis at an exit port of the polarizing beamsplitter.

14. The system of claim 12, wherein an optic axis of the quarter wave plate is rotated 45 degrees relative to the polarization direction of the light transmitted by the polarizing beamsplitter.

15. The method of claim 1, further comprising taking photographs or videos in low-light conditions.

16. A method for imaging with magnification comprising:
receiving light from a scene;
reflecting and polarizing the light into a first linear polarization;
transmitting the light through a substrate with a focal length;
reflecting the light;
rotating the polarization of the light so that the rotation results in a polarization orthogonal to the first linear polarization, wherein the light is orthogonally polarized light;
transmitting the orthogonally polarized light to a sensor to form an image; and
capturing an image of the scene.

17. The method of claim 16, wherein the light is reflected with a polarizing beam splitter.

18. The method of claim 17, wherein a polarizing beamsplitter polarizes the light and reflects the light to the sensor.

19. The method of claim 17, wherein a wave plate rotates the polarization of the light.

20. The method of claim 17, wherein the focal length of the imaging system is matched to the round-trip light path length.

21. The method of claim 17, further comprising autofocusing the image using PDAF (phase detection autofocus) sensing.

22. An imaging system for capturing light to form an image comprising:
a polarizing beamsplitter,
a substrate with a focal length,
a wave plate,
a reflector,
an imaging sensor positioned to receive light from the polarizing beamsplitter;
wherein the polarizing beamsplitter, wave plate, substrate with a focal length, and reflector are arranged along an axis, with the wave plate located between the polarizing beamsplitter and the reflector.

23. The method of claim 22, wherein light is reflected such that it propagates in the opposite direction to the input light path.

24. The method of claim 22, wherein light is reflected such that it propagates in the orthogonal direction to the input light path.

25. The method of claim 22, wherein a polarizing beamsplitter polarizes the light and diverts the reflected light to the sensor.

26. The method of claim 22, wherein a wave plate rotates the polarization of the light.
